(19) United States
(12) Patent Application Publication
(10) Pub. No.: US 2003/0071806 A1
(43) Pub. Date: Apr. 17, 2003

(54) Predetermined ordering system

(76) Inventor: Charles A. Annand, Truro (CA)

Correspondence Address: Charles A. Annand, 4 Ridgewood Drive, TRURO, NS, CA

(21) Appl. No.: 10/193,759

(22) Filed: Jul. 12, 2002

(30) Foreign Application Priority Data
Jul. 17, 2001 (CA) 2,354,256

(51) Int. Cl. G06T 1/00

(52) U.S. Cl. 345/418

(57) ABSTRACT

A system controlled by a predetermined coded scanning device, which would be relatively indestructible when attached to an article by some mechanical or heat seal means and could not be easily removed or altered, when attached to a refillable and reusable mug or container for coffee or some other product it will identify the container with the buyer and will place exactly the same product within the container when requested to do so by the buyer from the vendor of the specific product as programmed by the coded device. If the container is for coffee it is usually fitted with a removable cap, which would also have the same coded device on the cap as on the body of the container which will allow the buyer to place the cap on a sensor which will identify the name of the buyer and will open compartments to allow retrieval of the products after payment has been made at the coffee house or some other fast food type store, payments made by cash or by vendors prepaid debit system.

### CROSS REFERENCE TO RELATED APPLICATIONS

The enclosed invention relates to the inventor's previously applied for Provisional Patent in Canada, dated Jun. 12, 2001, U.S. Pat. No. No. 2,346,550, BAR CODE ORDERING SYSTEM

### BACKGROUND

1. Field of the Invention

A ordering system which uses these coded devices, to identify the person and also the product to be purchased, the coded device is made especially for the buyer by the vendor of a product which would then allow the buyer to receive the same product, in kind and quantity, on each occasion when the container with the attached coded device is presented to the vendor for a product refill.

2. Discussion of Prior Art

No directly related prior art was found that related directly to this invention.

### OBJECTS AND ADVANTAGES

Accordingly several objects and advantages of my invention are that the coded devices when semi-permanently attached to a reusable container could be covered with a clear (see through) plastic and may contain a Bar Code (as shown on drawings) or a Micro Chip with a Passive Coil and or a PIN Number device or a Magnetic Bar swipe device or such similar coded device which could be pre-programmed and securely attached to the container so it could not be altered in any way. As a practical example for the intended use of this invention when the device is attached to a conventional coffee mug made of plastic or some other sanitary food grade material the label would be semi permanently attached and heat fused or attached by some other means at an exact position in relation to the shape and body of the container so as when the buyer presented the container in the proper manner to a semi automatic coffee dispenser the coded device would be visible to a scanner in the same manner and location on each occasion. The buyer of the container to which the coded device was attached would be identified at each time that the product or service was requested by the persons name or by way of a code number given to that buyer by the vendor. The only other information recorded would be their phone number and any other non-critical information required by the system. The systems computer program would then provide the same product or service, which the buyer had ordered previously and which was recorded on the coded device of the container. The buyers name and product selection would be recorded in the vendor's store computer which would construct the bar code and affix them to the coffee mug and cap which would then be given to the customer.

Where the coded device was to be used in the case of a reusable and refillable coffee mug with a removable cap, the coded device would be on the top or bottom side of the cap. The cap would be removed by the buyer and used later to claim their container. The cap could be cleaned by the buyer or placed in a wash and dry area and then taken by the buyer to later claim the container. The buyer holding the container by the handle would place it directly in the receiver and a scanner would read the coded device. However, if the owner wished the container and the cap to be washed they could invert the mug and place it in the wash station for a hot water wash and then remove and place it in the receiver location for the scanner to read the coded device. The computer with a sound synthesizer would address the person by name and ask if they wished the same order. The buyer at this time could have several options as designed into the system and if the buyer wished to change the program they could do so by pressing various buttons, or the buyer would press “yes” to continue. A coded ticket would then be extended to the buyer to show the cost to be paid or if the buyer was on the vendors prepaid debit system the coded ticket would be marked paid and show the balance remaining. The upright container would continue to a fill station, milk and sugar would be added if pre-programed and then filled with the requested amount and type of coffee and other such ingredients as requested on the coded device would be added and the container would then be mechanically moved to a new position behind closed clear doors where the buyers name would be displayed to an attendant who would address the buyer by name, if they wished any other products. And also ask for their ticket to pay for their purchase and to place their top with the matching coded device to a flashing sensor to receive their purchase. These transactions would be displayed visually or could be done with a voice synthesizer. If the coded devices matched the buyer would know they were receiving their personalized container with the contents exactly as previously received, and the door to the container location would open and the container would be removed by the buyer and the top attached. The buyer could also request other products by pressing a series of buttons which would automatically release these products already bagged with a separate payment tab at the attendants station or order from the attendant. Another advantage with this coded device dispensing machine is to personalize the system by the vendor, as they would wish, with a visual display or with sound, with the owners name at various locations where it would be a benefit to the vendor and also the buyer.

This invention relates to a coded device and where it uses the bar code in the coded device it then resembles the conventional type commercial bar code as now used to identify a known product and the product manufacturer and as commonly seen on various retail products. However, this coded device with the bar-code system is the direct opposite in that, it is prepared by the vendor for a specific customer with their name and product wanted and attached to a container for that product. It then assures the buyer that they will receive the same product each time and in their own personalized container.

This invention would use a microcomputer in the retail store in combination with a main frame computer at a central or warehouse location with the program prepared by the vendor to quarantee that the buyer would receive the same product each time. The buyers name and size of coffee they purchased would be recorded in the microcomputer each time for comparing and verifying the coded device and debt transactions. At some convenient interval the vendor could have a “lucky winner” draw where the winner would be drawn from the number of times they purchased the product, by using their personalized mug with the coded device, which would then display the winners name in a visual and vivid display at the vendors store with various other promotions to promote the system and the vendor's products. The coded device would be programmed to only work in prearranged geographical locations as desired by the vendor.

The prepaid debit system would allow the buyer to make a paid deposit with the vendor, which would be automatically withdrawn from the deposit when a purchase was made with the coded device.

The purchase slips would show the amount spent and the balance remaining and would save the buyer the problems of money transfer at the time of purchasing the vendor's product. The buyers cap with the same coded device could at any time be displayed to a visible sensor to show the debit balance and to make a deposit in the prepaid account.

The semi-automatic dispensing system as indicated in the drawings as a combined unit could also be made in separate units.

The unit as shown in FIG. 5 would be a separate or independent type unit and could be placed at various locations in the vender's shop to increase traffic flow and customer convenience. These separate or combined units with the prepaid debit system will also function as “drive thru” units in a coffee shop or other quick food order location which will allow the vender more flexibility in placing the units for increased customer satisfaction. The “in and out” or Drive Thru refill dispensing station as shown in FIG. 5 allows the buyer to place his container with the coded device inside the unit through the open doors and the inside sensor will read his coded device will wash and fill his container as requested and issue a payment slip for the prepaid debit system which will allow the doors to open when activated by the coded device on the cap and the container can then be removed by the buyer. The buyers name is also displayed and any other functions such as a second quick wash by pressing certain pre-programmed buttons.

Accordingly my invention creates a means which will allow an individual buyer to be personally recognized at the store and other stores in the system and to enter a contest by the frequency of his purchasing and the winner would be recognized at the vendors shop. The use of the coded device on the coffee mug and the cap assures the buyer of personalized service with his own coffee mug and the same purchase each time with a cash payment or with a integrated prepaid debit payment system. Other products sold by the vendor can also be purchased with the coded device, directly by cash, or by the prepaid debit system.

The Predetermined Ordering System can be in the form of a Bar-code, as shown on the drawings, or a Micro Chip, or a Micro Chip and Passive Coil, or by a PIN Numbering system or by some other personal identification system.

### BRIEF DESCRIPTION OF THE DRAWINGS

This patent application will now be described merely by way of illustration with reference to the accompanying drawings in which:

FIG. 1—Is an isometric view of a refillable and reusable coffee mug when used with the identification system as outlined in my invention.

FIG. 2—Is a side view of a coffee mug with the cap removed and placed in automatic hot water station.

FIG. 3—Is a side view of a conventional coffee mug as manufactured by Aladdin under U.S. Pat. No. 5,916,470, and would be as used by my invention.

FIG. 4—Is a possible layout of a semi automatic coffee dispensing combination station as would be used in my invention.

FIG. 5—Is a front view of a possible single function dispensing station as would be used in a store “drive thru”.

FIG. 6—Is a plan view of a typical Bar Code which may be applied to a reusable coffee mug with the buyers/owners name.

### DETAILED DESCRIPTION OF THE INVENTION

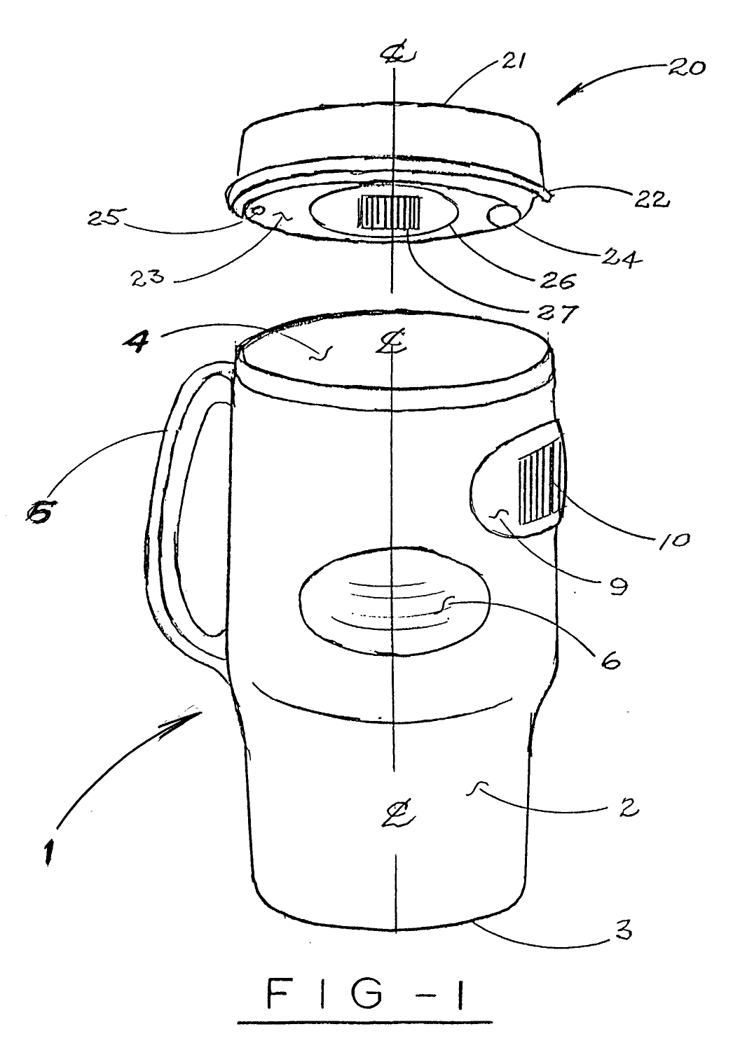

A predetermined ordering system where according to the invention when used as a container to receive coffee beverage from a vendor using the coded Bar Code device it would be as shown in FIGS. 1 to 6.

FIG. 1 shows the conventional coffee mug 1, with a plastic double shelled container with the outer shell 2 and inner shell 4 and bottom 3 with an integral handle 5 and a possible advertisement label 6 and the Bar Code, coding device 10 with a clear sealed plastic cover 9 to protect the coded device. If the coded device was a Micro-Chip or a Magnetic Bar it would conceivable be in the same location and protected by the same clear plastic seal 9. FIG. 1 also shows the cap/cover 20 which would fit on the container with lip 22 and a dam 21 for the coffee liquid, the underside 23 shows the vent 25 and outlet hole 24 for the liquid coffee. The coded device as a Bar Code 27 is shown on the bottom side 23 and covered by the plastic seal 26, however the seal and Bar Code could be on the top side if so desired by the manufacturer.

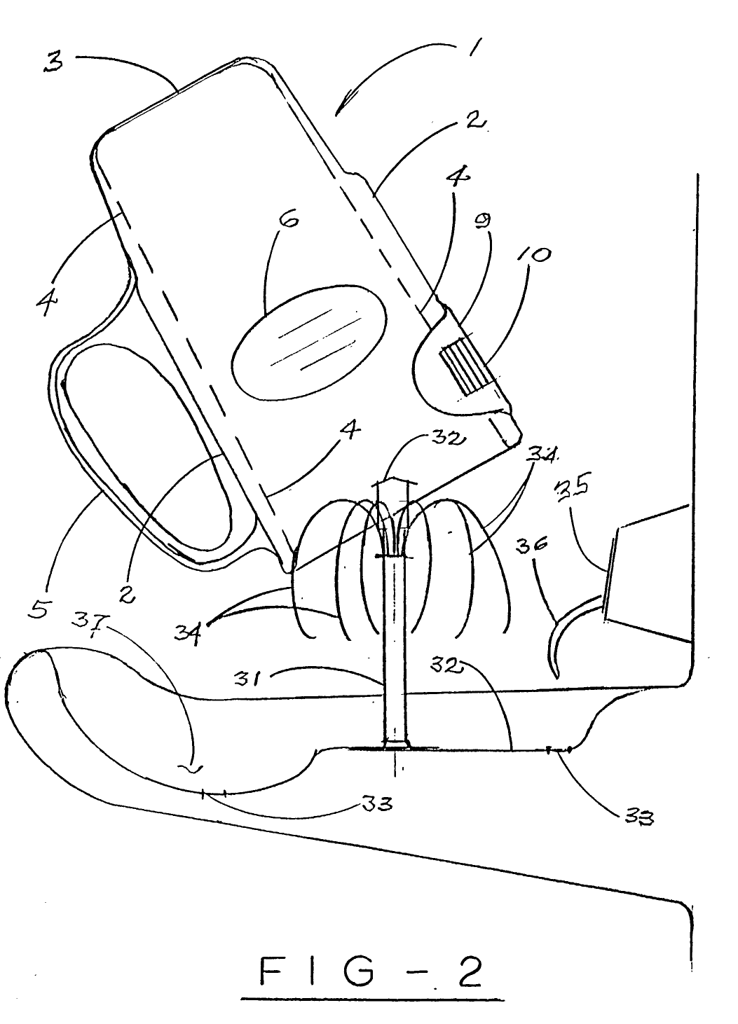

FIG. 2 is of an inverted Wash Station where the container for coffee 1 with outer shell 2 and inner shell 4 and bottom 3 with handle 5 and label 6 and Bar Code 10 with seal 9 is placed over the hot water spray pipe 31 and nozzle 32 with spring locators 34 and a sensor 35 to read the coded device, the spray switch 36 controls the hot water spray and cool air to the system as mounted on the receiver plate 32 with drain holes 33 and a receiving area 37 for the cover/cap of the container.

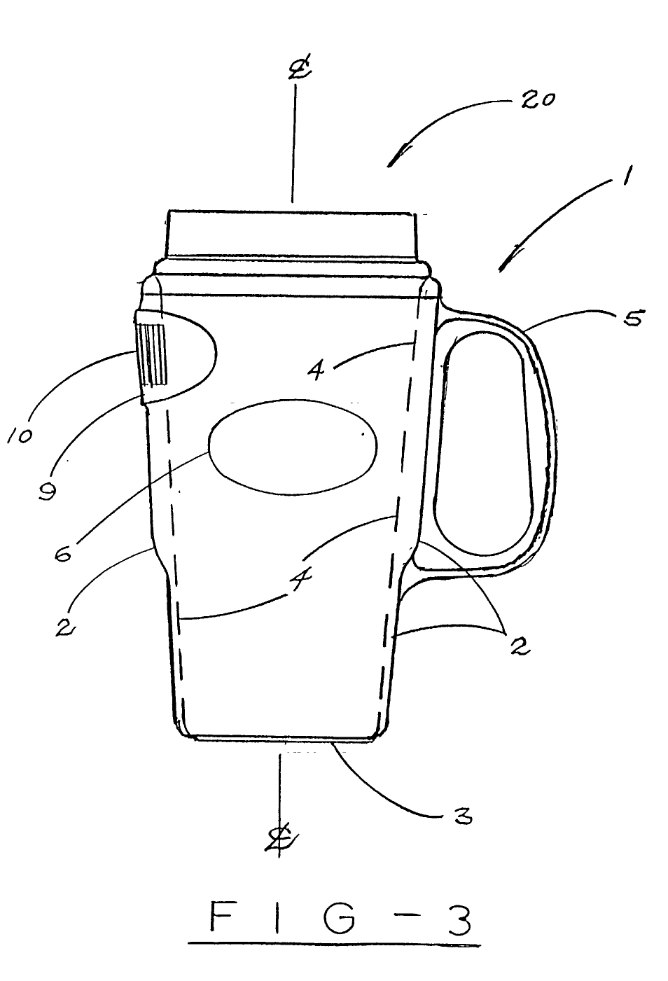

FIG. 3 is a side view of a typical container 1 with the same descriptive numbers as detailed in FIG. 1 with outer shell 2 and inner shell 4 and bottom 3 with handle 5 and label 6 and Bar Code 10 and covering seal 9. These containers could be of a food grade plaaastic or of a combination plastic and stainless steel or a double walled stainless steel and various manufacturers will have their own design methods of construction for the beverage industry and my coded systems may be attached to any such vessel or container and function as detailed in my invention.

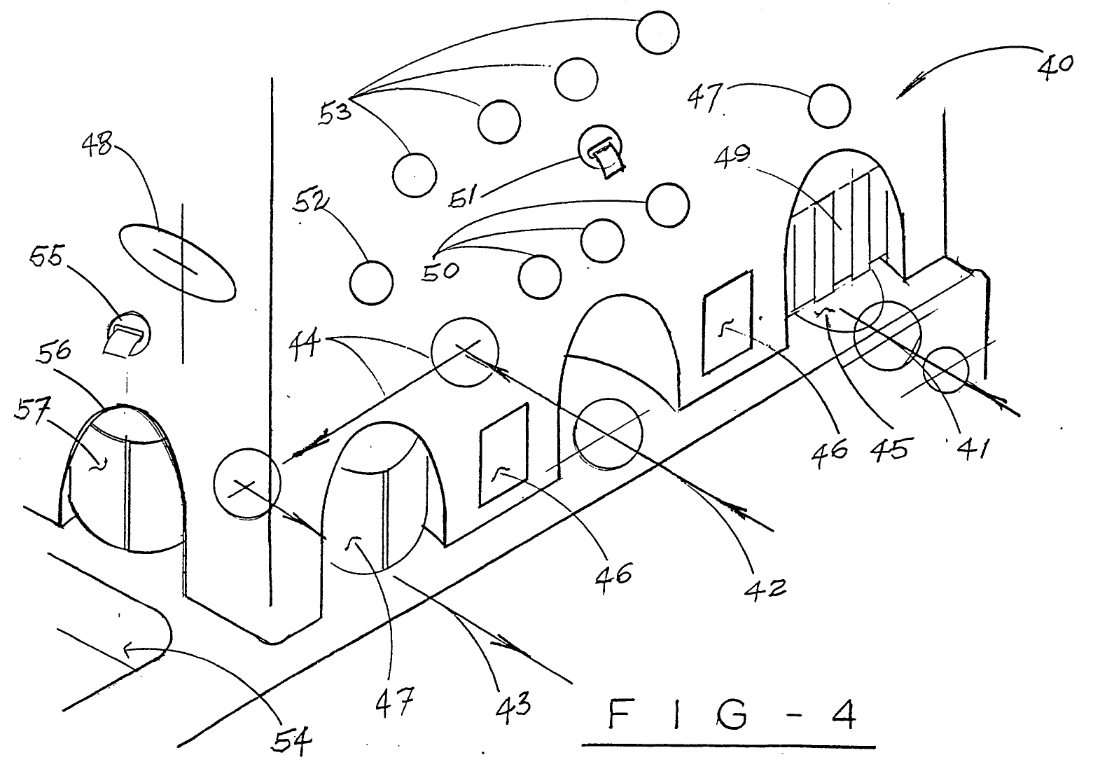

FIG. 4 is a possible layout of a container receiving station 40 for filling and dispensing a beverage such as coffee in a vendors store where the coffee container as previously described would be placed at 41 and through a splash curtain 49 with the cap/cover placed at 45 and the sensor 47 could give the container a second hot water wash if the owner placed his cap on the sensor 47. Paper napkin holders 46 could be as shown and receiver 42 for the container would be as shown and could be on a system to move the container through the system from 42 to 44 and out at 43 through the clear doors 47. Other sensors at 50 and 53 could be for other products or functions and would be activated by the owners cap/cover and the receipt/tab 51 for the debit system would exit as shown. If the vendor wishes to use a an attendant they would be located at the counter 54 when the customer's name and desired products would show on the screen 48 and other products could exit at doors 57 from area 56 and tab 55 would exit for these products. This system could be a semi-automated or fully automated and with or without an attendant.

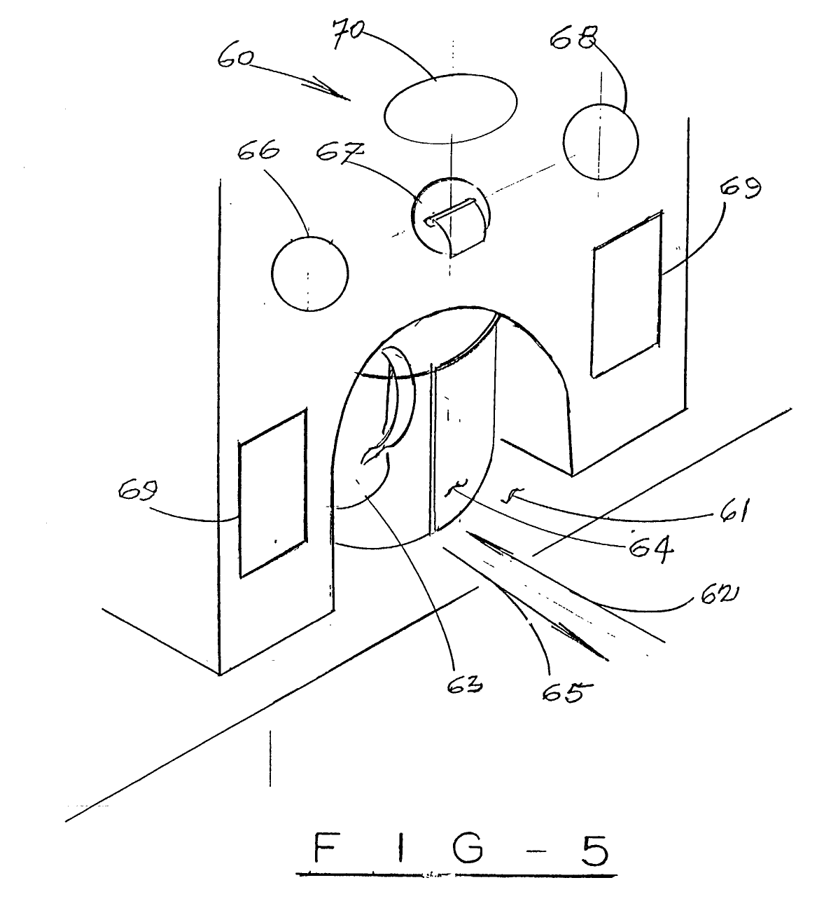

FIG. 5 is another possible arrangement for a container for coffee or some other beverage where the container is placed inside the open doors 64 by the buyer 62 with his container 63 where the scanner would read the coded device of either type as proposed and the owner's/buyer's name would be on a screen 70 with his selections. The napkin holders 69 and sensors 66 would give products as requested. And sensor 68 would be for the debit system with the receipt 67 exiting the system and the doors would open to retrieve the purchase.

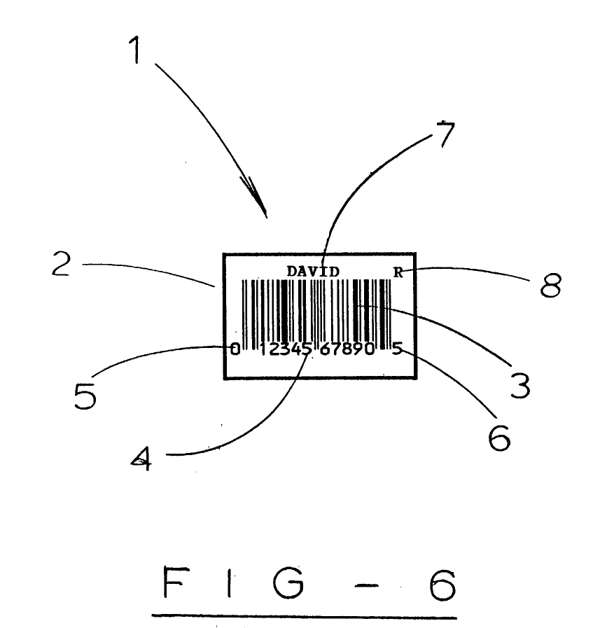

FIG. 6 in this coded system is showning the coded Bar Code 1 device with the adhesive backed label 2 and the owner's/buyer's Bar Code 3 and the vendor's code numbers 4 with other special related numbers 5 and 6 by the vendor. The buyer's name 7 is as shown and the R, 8, is if he is right handed and would be L if left handed.

I claim:

1. A beverage receptacle comprising a readable coded device affixed thereto and containing information relative to a user thereof.

2. A machine for dispensing a beverage, comprising;
means for receiving a beverage receptacle having a readable coded device affixed thereto;
means for reading information in said readable coded device;
means for associating said information with a beverage preference of a user of said beverage receptacle;
means for making a beverage according to said beverage preference, and
means for dispensing said beverage in said beverage receptacle.

3. A method for dispensing a beverage, comprising the steps of;
providing a beverage receptacle having a readable coded device affixed thereto, said readable coded device containing information relative to a user of said beverage receptacle;
reading information in said readable coded device;
interpreting said information and associating said information with a beverage preference of said user;
making a beverage according to said beverage preference, and
dispensing said beverage in said beverage receptacle.
